(19) United States
(12) Patent Application Publication
(10) Pub. No.: US 2006/0149606 A1
(43) Pub. Date: Jul. 6, 2006

(54) System and method for agent assisted information retrieval

(75) Inventors: Terrance L. Goan JR., Bellevue, WA (US); Ronald K. Braun, Seattle, WA (US); Ryan A. Kaneshiro, Seattle, WA (US); Laurie Spencer, Seattle, WA (US); Matthew Broadhead, Seattle, WA (US); Lynn J. Gasch, Kirkland, WA (US); Keith A. Weinberger, Seattle, WA (US)

Correspondence Address: MERCHANT & GOULD PC, P.O. BOX 2903, MINNEAPOLIS, MN, 55402-0903, US

(73) Assignee: Stottler Henke Associates, Inc., San Mateo, CA (US)

(21) Appl. No.: 11/030,572

(22) Filed: Jan. 5, 2005

(51) Int. Cl. G06Q 99/00; G06F 17/50; G06F 9/44

(52) U.S. Cl. 705/7; 705/1

(57) ABSTRACT

Online information resources are searched. The system acts an assistant to the user during the search of online resources by pursuing search paths that the user did not recognize, or was unable to pursue due to time or skill limitations. After constructing a preliminary model of the user's information need the system identifies a number of unexplored leads and pursues them with a user-defined level of autonomy. Pursuing leads may involve the exploitation of any number of heuristics through automated advanced query construction and Web crawling methods. Documents discovered during the search are evaluated for likely utility and presented to the user. Both explicit feedback and inferences drawn from the user's interaction with online information are used to continually refine the model of the user's information need thereby redirecting the search system.

### BACKGROUND OF THE INVENTION

Locating useful information on the World Wide Web, local area networks, or in the multitudes of specialty databases available online often proves very frustrating to computer users. This is not particularly surprising given that major internet search engines alone index billions of pages and there are estimated to be some 350,000 specialty databases not indexed by those search engines. Worse yet, the Web's growth rate of 7 million pages/day only hints at its dynamic nature—with huge volumes of content being updated or added constantly.

The ever-burgeoning Internet provides users with access to billions of electronic documents—with perhaps hundreds of millions of documents being added or changed daily. Information technology has also lead to massive increases in the publication of information within the internal networks of large and small organizations. But the sheer size and dynamism of these online resources, together with the large heterogeneous collection of available search tools, can make a search for useful information very difficult.

Ever since the development of the very earliest information retrieval systems, researchers have sought to improve the situation. One known method is Relevance Feedback in which the user feeds back notions of which query results were relevant/irrelevant to the current query. This data could then be employed by the information retrieval system to recalculate the relative importance of key words, expand the user's query to improve precision, and/or to re-rank query results. While Relevance Feedback is theoretically powerful, current implementations have shown limited utility and have not been widely adopted by users.

A number of information retrieval systems take an alternative approach to improving queries which takes the form of an interactive query refinement process. This approach allows the user to refine their query through the addition of one or more system generated related terms that may more accurately reflect the user's objective. Unfortunately, this approach offers little except when users are seeking very general interest information.

Moving beyond the objective of improving specific queries and seeking to address user interface issues, researchers have developed so called “zero-input” personalization systems to provide users with awareness of content similar to documents they discover during search and browsing. Unfortunately, these zero-input interfaces trade reduced user input requirements for efficacy and leave the user without a feeling of control.

### SUMMARY OF THE INVENTION

Emodiments of the present invention relate to a method and system for enhancing users' abilities to efficiently conduct thorough online searches.

According to one aspect of the invention, three components are utilized in searching, including: (1) an information need modeling system; (2) a lead pursuit system; and (3) a search post-processor.

According to another aspect of the invention, interaction between the system and the user begins with a preliminary modeling of the user's information need. This information need modeling can proceed through any combination of direct user specification and through the automated analysis of user actions and rated documents. The information need model associated with the user may take many forms. According to one embodiment, the user's information need model includes a set of rated documents, ranked multi-word terms, and document references (such as in the form of Uniform Resource Locators (URLs)).

According to yet another aspect of the invention, the information need model is dynamic in nature. In other words, the information need model is continually adapted based on user input and explicit and implicit feedback in order to track the user's changing needs over time. Essentially this model represents a collection of “leads.”

According to another aspect of the invention, a Lead Pursuit System evaluates the available leads to estimate their likely value in discovering new information relevant to the user's information need. The lead pursuit system is also directed at allowing the user to provide as much or as little input into this prioritization of these leads as they desire. The Lead Pursuit System then processes the most promising leads in accordance with an established schedule and/or in response to explicit user input. The manner in which particular leads are pursued in a search depends on their type. For instance, indicative and counter-intuitive terms may be combined to form Boolean queries to Web search engines or other information retrieval systems. Other leads of specific types such as bibliographic information (e.g., names, titles, subjects or reference numbers) can be exploiting using the advanced search features of the information retrieval systems. URLs can alternatively be used in specialized queries such as AltaVista™'s “like:” (to retrieve related documents) and “link:” (to retrieve documents containing that URL) queries, as seeds for a focused crawling process, or can be monitored for document content changes. Alternatively, the user may explicitly create a query and task the Lead Pursuit System to execute it unaltered. Pursuing the leads is directed to the discovery of documents (e.g., Web pages or meta-tagged data files) which are then passed to the search post-processor.

According to still yet another aspect of the invention, a search post-processor removes duplicates (documents previously rated by the user) and scores documents according to one of many potential ranking functions which may draw on a variety of data including, but not limited to: identified key terms, references (e.g., URL or bibliographic references) to/from documents previously rated as useful, source credibility information, community ratings, and the like. According to one embodiment, it has been found effective to rank search results through a simple summation of the scores associated with the identified indicative (positive scoring) features (i.e., key terms, named entities, references) and counter-indicative (negative scoring) features that are found within each result. Once scored search results can be presented to the user in any number of fashions. For example, the results may be presented in a linear list, each displayed with associated summary text and a list key terms that match those found in the information need model. Other options include displaying search results within the context of dynamic summaries of documents the user has previously labeled as useful to the user's search tasks. These summaries display information regarding the contents and properties (e.g., document type, length, summary) of the document as well as lists of the most similar (by content overlap) and/or related (by shared references, source, or the like) documents that have been discovered.

According to still yet another aspect of the invention, at any time during the process, the user may refine his information need model and or manipulate the list of identified leads by providing explicit feedback on discovered document, key terms, or URLs. The information need model may also be refined in response to the automated analysis of user activities and new document discoveries. In this manner the information need model is continually and iteratively refined to track the user's evolving information need.

### BRIEF DESCRIPTION OF THE DRAWINGS

FIG. 1 illustrates an agent assisted search system;

FIG. 2 shows a detailed view of an Information Need Modeling System;

FIG. 3 illustrates a schematic diagram of an exemplary network overview, in which the invention may operate;

FIG. 4 shows a schematic diagram illustrating an exemplary computing device;

FIG. 5 illustrates a process identifying and scoring key multi-word terms;

FIG. 6 shows a lead list merger process;

FIG. 7 illustrates integrating user ratings with the system derived Calculated Scores; and

FIG. 8 shows a process for evaluating the usefulness of documents, in accordance with aspects of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. Each embodiment is described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

The term “lead” refers to a piece of information that can be used by the system to search for information that may fulfill the user's information need. Examples of leads are indicative and counter-indicative key terms and URL's, and rated documents. In practice a lead in the form of a document may contain multiple leads itself (e.g., key terms, URL's, bibliographic entries) which may be extracted and pursued.

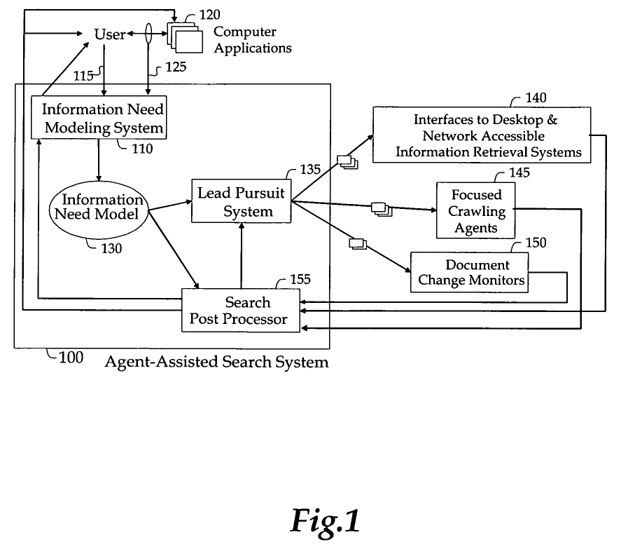

FIG. 1 illustrates an agent assisted search system, in accordance with aspects of the invention. System 100 includes an Information Need Modeling System 110, which takes input from a user in the form of Leads and Explicit Relevancy Feedback 115, as well as Implicit Feedback 125 that is collected by observing the users actions with computer applications or Web services. The Information Need Modeling System 110 generates an Information Need Model 130 which codifies the state of the user's search task and available leads.

The Information Need Model 130 is the primary input to the Lead Pursuit System 135, which is used to coordinate the system's search efforts on behave of the user. The Lead Pursuit System 135 utilizes the state of the search and the leads codified in the Information Need Model 130 to construct multiple queries to online Search Tools 140, directives to focused Crawling Agents 145, and/or directives to Document Change Monitors 150.

The results of the search efforts are analyzed by the Search Post-Processor 155, which removes duplicate documents, and then scores and presents results to the user. The presentation of results can take different forms. The Search Post-Processor 155 may also provide feedback to the Lead Pursuit System 135 and will continually collect statistics that may affect the perception of the user's information need or the value of particular leads or combinations of leads.

As search results are returned to the user by the Search Post-Processor 155, the user may provide feedback as to the relevance of the returned results, add/delete/re-rate leads, or otherwise provide refined search guidance through interaction with the Information Need Modeling System 110. The Information Need Modeling System 110 may gather further information by observing the user's continuing interaction with other software applications and Web services.

Modeling the User's Information Need

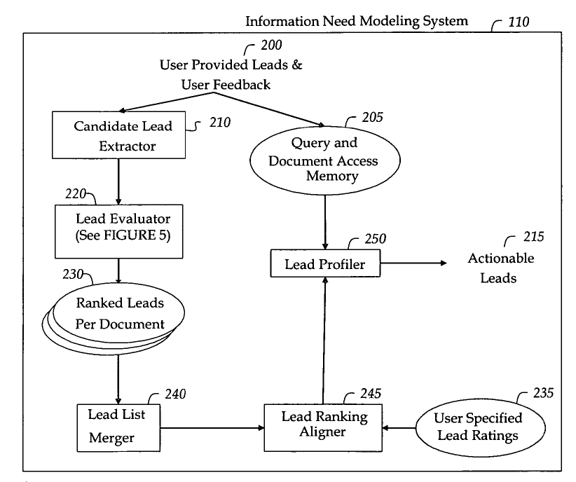

FIG. 2 shows a detailed view of the Information Need Modeling System 110 as illustrated in FIG. 1, in accordance with aspects of the present invention. Information need modeling system 110 takes as input a set of User Provided Leads and User Feedback 200 provided by the user of the system (or is gathered by monitoring their activities) and produces a set of Actionable Leads 215. User Provided Leads and User Feedback 200 can take a number of forms including: query strings; rated documents/passages, meta-tagged data objects, lists of key-terms, or unexplored document references (e.g., URLs). In one embodiment the user indicates perceived relevance through a multi-value rating system: (+) useful and (−) off-topic, and (X) topically relevant but low-value/duplicative, and (?) unevaluated but potentially useful. For the purposes of estimating the user's information need the “+” and “−” rated documents are employed, while “X” and “?” rated documents are used in lead pursuit and to control search results display (see the following sections).

Most directly, the incoming User Provided Leads and User Feedback 200 provide the Information Need Modeling System 110 with a Query and Document Access Memory 205 which retains information as to which queries were posed and which documents have been accessed during the current search task. These queries and documents may be accessed through the current system or through other software applications and Web services monitored by the current system. This information is utilized by the Search Post Processor 145 in the removal of duplicates and may also be used by the Lead Pursuit System 135 (see FIG. 1) in the selection of appropriate search services to utilize to fulfill a user's information need and which leads are most viable. For example, the user may seek a document that they know was previously viewed, or alternatively wish to discover documents that are new.

User Provided Leads and User Feedback 200 that take the form of documents are also further processed by the Lead Extractor 210, which seeks to extract additional leads that may prove useful in the search. For instance a document may include useful leads such as key terms, URL's, and bibliographic entries. There are many known ways to extract candidate of different types. In one embodiment the extraction of candidate leads involves the extraction of special text strings of interest such as proper nouns and document references (e.g., URL's and bibliographic references), as well as the statistical analysis of other multi-word strings for significance the user's information need. Generally, any method for proper noun and document reference extraction may be utilized according to embodiments of the invention.

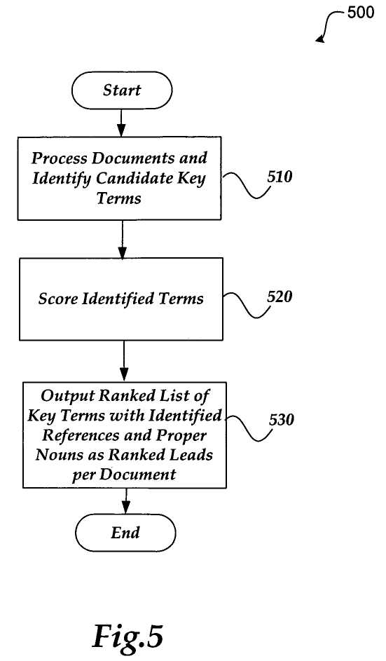

FIG. 5 illustrates a process identifying and scoring key multi-word terms, in accordance with aspects of the invention. In this embodiment the Lead Evaluator 220 processes documents and identifies candidate key terms (block 510) that match the following constraints:

1. Do not cross a phrase/sentence demarcation

2. Do not start or end with a stop word

3. Do not always appear as a sub-term of another particular term

4. Appear at least twice within the document being processed

Lead Evaluator 220 then scores the identified terms (block 520) utilizing simple heuristics such as TF*TL (term_frequency*term_length (in words)) and outputs a ranked list of key terms together with identified references and proper nouns as Ranked Leads Per Document 230 (block 530). In this embodiment, the Lead Evaluator 220 determines the initial list of Ranked Leads for each newly added document, and only does this list calculation once per document.

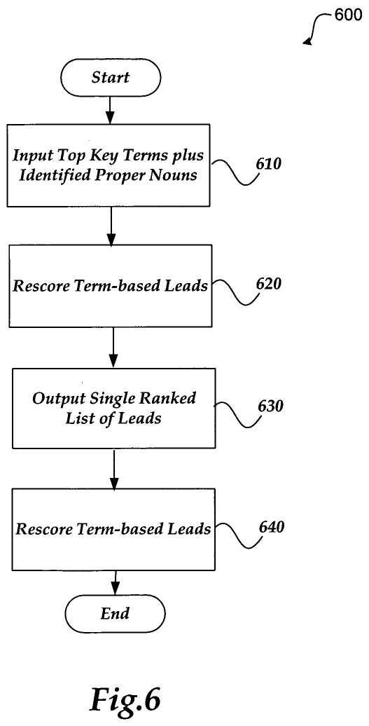

Lead List Merger 230 (See FIG. 2) then takes as input the top key terms plus the identified proper nouns from each document rated by the user. FIG. 6 shows a lead list merger process, in accordance with aspects of the invention.

According to one embodiment, the top 50 key terms plus the identified proper nouns from each document rated by the user are taken as input (block 610). Document references are not scored and are handled separately. Term-based leads in this merged list are then rescored (block 620) according to the following formula:
Calculated Score=Log₂((qPos*(1−qNeg))/(qNeg*(1−qPos))+Log₁₀(TF*TL)
Where totalPositive is the number of documents rated “+”, and totalNegative is the number of documents rated “−”. TL is the number of words comprising the term. For document references TL=1.
If the lead appears in at least one “+” document then:
   qPos=numPositive/totalPositive
   qNeg=1/(totalPositive+totalNegative+0.1)
   TF=the frequency with which the term appears in the “+” rated documents otherwise:
   qPos=1/(totalPositive+totalNegative+0.1)
   qNeg=numNegative/totalNegative
   TF=the frequency with which the term appears in the “−” rated documents

The output of the Lead List Merger 230 is then a single ranked list of leads (block 630). This list is then passed to the Lead Ranking Aligner 245 (block 640) which is responsible for integrating user ratings with the system derived Calculated Scores.

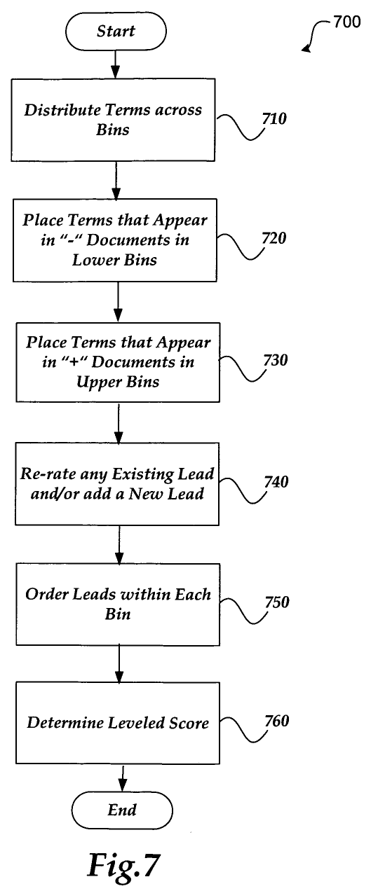

FIG. 7 illustrates integrating user ratings with the system derived Calculated Scores, in accordance with aspects of the invention.

In this process document references are treated differently than term based leads. In particular, terms are distributed across a set of bins associated with a five point rating scale (block 710). Terms that appear only in “−” documents are distributed only within the bottom two bins—the lowest-scoring 30% in the lowest bin and the remaining 70% in the second lowest bin (block 720). Terms that appear in at least one positive document are distributed in the remaining three bins—the highest-scoring 20% in the highest bin, 30% in the second highest bin, and the remaining 50% in the middle bin (block 730).

The user may then rerate any existing lead, and/or add a new lead with any of the five ratings associated with these bins (block 740). According to one embodiment, the observed user query terms are give the highest of the five ratings. The leads within each bin are then ordered according to their (possible zero) Calculated Score (block 750). Once the leads are ordered they are given a new “leveled score” (block 760) which is calculated as follows:
Lowest bin: If X=1 then leveled score=−20
   otherwise leveled score=−6−(14/(X−1)*(|P−X|−1)).
Second lowest bin: If X=1 then leveled score=−4
   otherwise leveled score=−1−(3/(X−1)*(|P−X|−1)).
Middle bin: leveled score=0
Second highest bin: If X=1 then leveled score=4 otherwise leveled score=1+(3/(X−1)*P).
Highest bin: If X=1 them leveled score=20 otherwise leveled score=6+(14/(X−1)*P)

Where:

X=number of uniquely internally-scored terms in the bin

P=the term's position in bin ordering

The final component of the Information Need Modeling System 110 is the Lead Profiler 250 which takes as input the aligned (i.e., binned and rescored) term-based leads and the set of document reference based leads and tracks the likely utility of pursuing those leads. In one embodiment the system tracks the effectiveness of leads when employed in queries. More specifically the system monitors a lead's “traction” which is the number of search results rated “+” by the user that have been returned in the last ten uses of the lead as an “anchor” in search queries. In order to encourage the use of new leads provided by the user, these leads are given an initial of 10.

Lead Pursuit

The Lead Pursuit System 135 (see FIG. 1) utilizes information regarding the state of the user's search in the form of the Query and Document Access Memory 205 (see FIG. 2) and the set of ranked Actionable Leads 215 (see FIG. 2) to pursue useful information on behalf of the user.

A search may be triggered by a scheduled event, by explicit user request, or by an observed change in the Information Need Model and may involve the utilization of Document Change Monitors 150, Focused Crawling Agents 145, and/or Interfaces to Desktop & Network Accessible Information Retrieval Systems 140 among other tools depending on the type of lead and the state of the Information Need Model 130.

In one embodiment queries to Information Retrieval Systems 140 are probabilistically formed with care taken to avoid the issuing of substantially similar queries within a period of time where changes are unlikely to be found in query results.

There are many forms that queries could take, but in one embodiment of the current invention, queries are composed of an anchor term A, a positive context PC, and possibly a negative context NC and the form of the query varies across different information retrieval systems, but a prototypical form is: A AND (PC, OR PC₂ OR PC₃ OR PC₄ . . . ) ANDNOT NC₁ ANDNOT NC₂ ANDNOT NC₃ . . . It has been found that selecting NC terms that co-occur with the anchor term in “−” rated documents produces better search results.

Queries may also be produced for specialized information retrieval interfaces utilizing specific types of identified leads such as named entities and references (e.g., URLs). For instance AltaVista™'s “like:” (to retrieve related documents) and “link:” (to retrieve documents containing that URL) special terms can be used as query elements to find (or exclude) pages that are related to pages the user has rated as useful. It has been found useful to employ “link:” type queries to retrieve up to 50 results that contain each URL rated “+” by the user.

One special case involving query generation is the formation of queries utilizing these specialized search services to uncover pages that reference multiple documents rated by the user as useful. Pages retrieved utilizing such queries take on special meaning within some embodiments of the current invention as “hubs” and receive special attention in that references from such pages can automatically be extracted and used to retrieve a further set of potentially useful documents.

In addition to forming and distributing queries through Interfaces to Information Retrieval Systems 130, some embodiments of the current invention can employ Focused Crawling Agents 135 to discover addition potentially useful documents. There are many known techniques for directing Focused Crawling Agents 135, but in one embodiment of the current invention the search is seeded with documents that the user has rated as “+” and any identified “hubs”, and then any discovered pages are evaluated for relevance using the same metric utilized by the Search Post-Processor 155 discussed below.

The user may also request that certain documents be monitored for changes utilizing Document Change Monitors 150. In one embodiment the user may specify a schedule according to which previously discovered “+” documents are checked for important changes. The use can further specify which forms of change are of interest including the possibility that the document changes should be evaluated as a new search result by passing it to the Search Post-Processor 155.

Search Post-Processing

The Search Post Processor 155 is responsible for evaluating the usefulness of documents discovered through the Lead Pursuit System 135 and processing them so as to support effective presentation to the user.

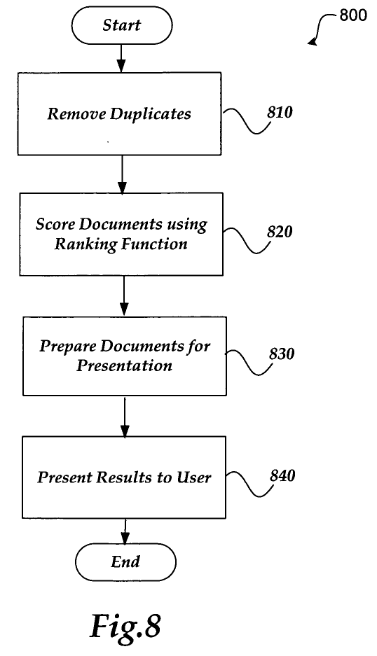

FIG. 8 shows a process for evaluating the usefulness of documents, in accordance with aspects of the invention. The Search Post-Processor 155 first remove duplicates—documents previously rated by the user and not tagged for monitoring (block 810). The remaining documents may then be scored according to many potential ranking functions (block 820). According to one embodiment, the score of a search result is simply the sum of the scores of leads found in the abstracts returned by the search engines used in lead pursuit. Users may also opt to use the same scoring function but on the entire text of the search result instead of the abstract.

In addition to scoring, the Search Post Processor 145 may do further processing to improve the presentation of the search results (block 830). For example, methods including, but not limited to, clustering, visualizations, and multi-document summarization techniques may be used. The results are then presented to the user (block 840). In one embodiment, search results are presented in a linear list, each displayed with associated summary text, a list key terms that match those found in the Information Need Model, and a numeric score. It has been found effective to continue search during the users own independent search and browsing efforts—developing a list of the best results for review when the user is ready.

In another embodiment, search results are displayed within the context of dynamic summaries of documents the user has previously labeled as relevant to the user's search tasks. These summaries, called Active Reports, display information regarding the contents and properties (e.g., document type, length, summary) of the document as well as lists of the most similar (by content overlap) and/or related (by shared references, source, or the like) documents (both previously rated documents and new search results).

Illustrative Operating Environment

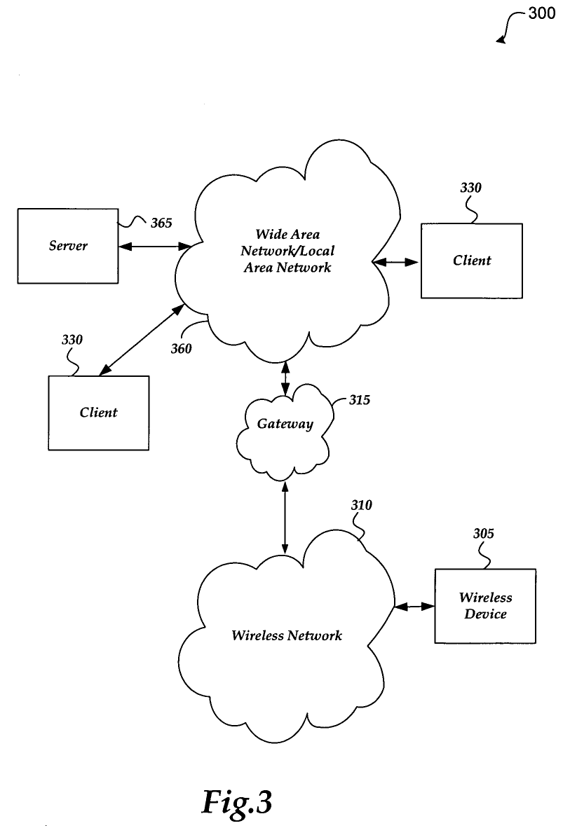

With reference to FIG. 3, an exemplary agent assisted search system 300 in which the invention operates includes one or more wireless devices 305, wireless network 310, gateway 315, wide area network (WAN)/local area network (LAN) 360, one or more client devices 330, and one or more servers 365.

Server 365 couples to WAN/LAN 360 through communication mediums and is configured to search online information resources and provide results to users, such as client devices 330 and wireless device 305.

Wireless device 305 couples to wireless network 310 and includes any device capable of connecting to a wireless network such as wireless network 310. Such devices include cellular telephones, smart phones, pagers, radio frequency (RF) devices, infrared (IR) devices, citizen band radios (CBs), integrated devices combining one or more of the preceding devices, and the like. Wireless device 305 may also include other devices that have a wireless interface such as PDAs, handheld computers, personal computers, multiprocessor systems, microprocessor-based or programmable consumer electronics, network PCs, and the like.

Wireless network 310 transports information to and from devices capable of wireless communication, such as wireless device 305. Wireless network 310 may include both wireless and wired components. For example, wireless network 310 may include a cellular tower linked to a wired telephone network. Typically, the cellular tower carries communication to and from cell phones, pagers, and other wireless devices, and the wired telephone network carries communication to regular phones, long-distance communication links, and the like.

Wireless network 310 couples to WAN/LAN through gateway 315. Gateway 315 routes information between wireless network 310 and WAN/LAN 300. For example, wireless device 305 may access network 360 using gateway 315. Gateway 315 may translate requests for web pages from wireless devices to hypertext transfer protocol (HTTP) messages, which may then be sent to WAN/LAN 360. Gateway 315 may then translate responses to such messages into a form compatible with the requesting device. Gateway 315 may also transform other messages sent from wireless devices 305 into information suitable for WAN/LAN 360, such as e-mail, audio, voice communication, and the like.

Typically, WAN/LAN 360 transmits information between computing devices. One example of a WAN is the Internet, which connects millions of computers over a host of gateways, routers, switches, hubs, and the like. An example of a LAN is a network used to connect computers in a single office. A WAN may connect multiple LANs.

Client 330 couples to WAN/LAN 360 and includes any device capable of connecting to a data network, and is configured to initiate and view results of searches.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

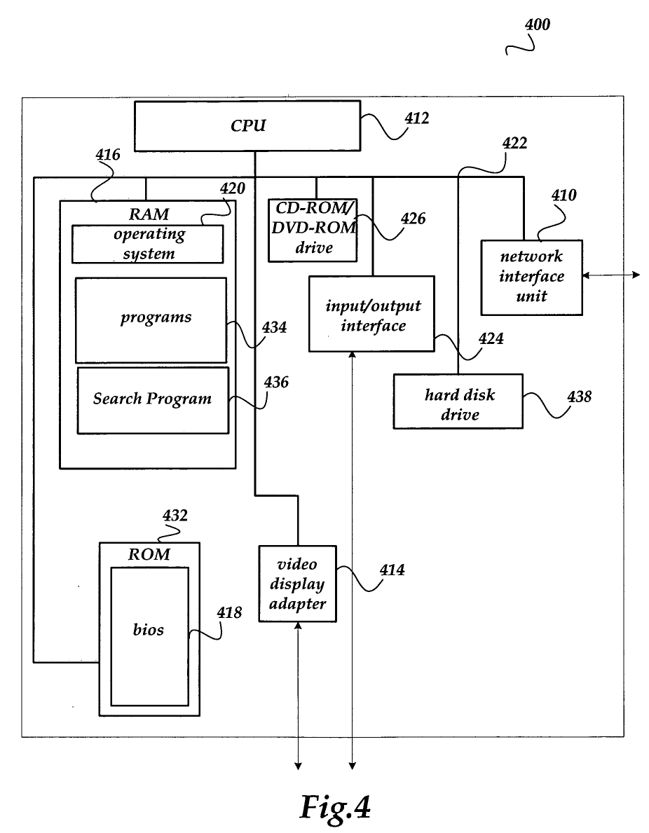

FIG. 4 shows an exemplary computing device, in accordance with aspects of the invention. Computing device 400 may be configured as a server, a client, or a wireless device.

Device 400 may transmit and receive data relating to search information. When configured as a server, device 400 may transmit WWW pages to a WWW browser application program executing on devices (wireless device 305 and client 330) to display search related information. For instance, server 365 displayed in FIG. 3 may transmit pages and forms for receiving search input and displaying search related information. The transactions may take place over the Internet, WAN/LAN 300, or some other communications network.

Computing device 400 may include many more components than those shown in FIG. 4. However, the components shown are sufficient to disclose an illustrative embodiment for practicing the present invention.

As shown in FIG. 4, computing device 400 may connect to WAN/LAN 360, wireless network 310, or other communications network, via network interface unit 410. Network interface unit 410 may be wired or wireless, and includes the necessary circuitry for connecting computing device 400 to the desired network, and is constructed for use with various communication protocols including the TCP/IP protocol. Typically, network interface unit 410 is a card contained within computing device 400. Network interface unit 410 may include a radio layer (not shown) that is arranged to transmit and receive radio frequency communications. Network interface unit 410 connects computing device 400 to external devices, via a communications carrier or service provider.

Computing device 400 also includes central processing unit 412, video display adapter 414, and a mass memory, all connected via bus 422. The mass memory generally includes RAM 416, ROM 432, and one or more permanent mass storage devices, such as hard disk drive 438, a tape drive, CD-ROM/DVD-ROM drive 426, and/or some other drive. The mass memory stores operating system 420 for controlling the operation of computing device 400. This component may comprise a general purpose server operating system, such as UNIX, LINUX™, Microsoft WINDOWS XP®, and the like. Basic input/output system (“BIOS”) 418 is also provided for controlling the low-level operation of computing device 400.

The mass memory also stores program code and data. More specifically, the mass memory stores applications including programs 434, and search program 436. The programs may include computer executable instructions which, when executed by computing device 400, generate WWW browser displays, including performing the logic described herein.

Computing device 400 may also comprises input/output interface 424 for communicating with external devices, such as a mouse, keyboard, scanner, or other input devices not shown in FIG. 4. Hard disk drive 438 is utilized by computing device 400 to store, among other things, application programs, databases, and program data used by search program 436.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for retrieving documents, comprising:
generating a model of a user's information need;
evaluating leads present in the model to determine search paths;
determining the leads to pursue in response to the evaluation;
pursuing the determined leads, wherein at least one of the leads may be pursued using a different method from the other leads; and
obtaining documents as a result of the pursuit.

2. The method of claim 1, further comprising analyzing the discovered documents, ranking the discovered documents and presenting search results to the user.

3. The method of claim 1, further comprising dynamically refining the model of the user's information need in response to at least one of the following: an explicit user input; the analysis of discovered documents; and the analysis of the user's activities.

4. The method of claim 3, wherein the each of the leads is one of the following types: a single word term; a multi-word term; a user query; a relevant document and attributes thereof; and a reference to documents.

5. The method of claim 3, wherein pursing the leads comprises determining a type of the lead and pursing the lead based on the determined type.

6. The method of claim 3, wherein the user may directly add, delete, reprioritize, and mandate which leads to pursue.

7. The method of claim 3, wherein pursuing the determined leads comprises simultaneously pursing the determined leads.

8. The method of claim 3, wherein evaluating the leads, determining the leads, and pursuing the determined leads may be initiated by at least one of: an explicit user request, a scheduled event, and a change in the model of the user's information need.

9. The method of claim 2, wherein presenting the search results comprises dynamically updating the search results presentation as the search results are re-evaluated and new search results are retrieved.

10. A computer-readable medium having computer executable instructions for retrieving documents, comprising:
generating a model of a user's information need;
evaluating leads present in the model to determine search paths;
determining the leads to pursue in response to the evaluation;
pursuing the determined leads, wherein at least one of the leads may be pursued using a different method from the other leads;
obtaining search results as a result of the pursuit, wherein the search results include documents; and
presenting the search results to the user.

11. The computer-readable medium of claim 10, further comprising dynamically refining the model of the user's information need in response to at least one of the following: an explicit user input; the analysis of discovered documents; and the analysis of the user's activities.

12. The computer-readable medium of claim 11, wherein the each of the leads is one of the following types: a single word term; a multi-word term; a user query; a relevant document and attributes thereof; and a reference to documents.

13. The computer-readable medium of claim 11, wherein pursing the leads comprises determining a type of the lead and pursing the lead based on the determined type.

14. The computer-readable medium of claim 11, wherein the user may directly add, delete, reprioritize, and mandate which leads to pursue.

15. The computer-readable medium of claim 14, wherein pursuing the determined leads comprises simultaneously pursing the determined leads.

16. A system for retrieving documents, comprising:
a processor and a computer-readable medium;
an operating environment stored on the computer-readable medium and executing on the processor;
a communication connection device operating under the control of the operating environment;
an application operating under the control of the operating environment and operative to perform actions, including:
generating a model of a user's information need;
evaluating leads present in the model to determine search paths;
determining the leads to pursue in response to the evaluation;
pursuing the determined leads, wherein at least one of the leads may be pursued using a different method from the other leads;
obtaining search results as a result of the pursuit, wherein the search results include documents; and
presenting the search results to the user.

17. The system of claim 16, further comprising dynamically refining the model of the user's information need in response to at least one of the following: an explicit user input; the analysis of discovered documents; and the analysis of the user's activities.

18. The system of claim 17, wherein the each of the leads is one of the following types: a single word term; a multi-word term; a user query; a relevant document and attributes thereof; and a reference to documents.

19. The system of claim 16, wherein pursing the leads comprises determining a type of the lead and pursing the lead based on the determined type.

20. The system of claim 16, wherein the user may directly add, delete, reprioritize, and mandate which leads to pursue.
